(19) United States
(12) Patent Application Publication
(10) Pub. No.: US 2015/0360680 A1
(43) Pub. Date: Dec. 17, 2015

(54) METHOD FOR STARTING A COMBUSTION ENGINE IN A HYBRID VEHICLE

(71) Applicant: SCANIA CV AB, Södertälje (SE)

(72) Inventors: Niklas PETTERSSON, Stockholm (SE); Mikael BERGQUIST, Huddinge (SE); Johan LINDSTRÖM, Nyköping (SE); Anders KJELL, Ekerö (SE); Mathias BJÖRKMAN, Tullinge (SE)

(21) Appl. No.: 14/410,652

(22) PCT Filed: Jun. 26, 2013
(86) PCT No.: PCT/SE2013/050779

§ 371 Date: Dec. 23, 2014

(30) Foreign Application Priority Data
Jun. 27, 2012 (SE) 1250711-7

(51) Int. Cl. B60W 20/00; B60W 10/18; B60W 10/115; B60W 10/08; B60W 10/06

(52) U.S. Cl. CPC B60W 20/40; B60W 10/08; B60W 10/06; B60W 10/115; B60W 10/182; B60W 2710/1005; B60W 2710/081; B60W 2710/065; Y10S 903/93

(57) ABSTRACT

A method for starting a combustion engine (2) in a propulsion system (1) of a hybrid vehicle, the propulsion system includes a planetary gear having three components: a sun gear (10), a ring gear (11) and a planet wheel carrier (12). The output shaft (2a) of the combustion engine connected to a first component of the planetary gear, an input shaft (3a) of a gearbox (3) connected to a second component of the planetary gear and a rotor (9b) of an electric machine (9) connected to a third component of the gearbox. The vehicle is set in an initial position with a suitable gear engaged in the gearbox and with a brake acting on the input shaft of the gearbox. After the electric machine is controlled so that the ring gear is brought into a negative rotation speed (n₃) and the output shaft (2a) of the combustion engine is, via the sun gear, brought to rotate with a positive rotation speed (n₁) so that the combustion engine may be started.

### FIELD OF THE INVENTION AND PRIOR ART

The present invention relates to a method for starting a combustion engine in a propulsion system of a vehicle according to the preamble of appended claim 1.

The invention is especially, but not exclusively, directed to carrying out such a method for motor vehicles in the form of wheeled utility vehicles, especially heavy such vehicles, such as trucks and buses.

The inventive method relates to starting of a combustion engine in a propulsion system of a so-called hybrid vehicle, which generally is a vehicle which may be driven by a primary engine, here a combustion engine, and a secondary engine, here an electric machine. The electric machine is suitably provided with at least one hybrid energy storing means, for example a battery or a capacitor, for storing electric energy and regulating equipment for regulating the flow of electric energy between the energy storing means and the electric machine. The electric machine may thereby alternately operate as motor and generator depending on the state of operation of the vehicle. When a brake is applied to the vehicle, the electric machine generates electric energy which may be stored and/or utilised directly. The stored electric energy may later be utilized for example for driving the vehicle.

The utilization of a conventional clutch mechanism connecting the input shaft of the gearbox with the combustion engine upon take-off of the vehicle and disconnecting it during a gear changing process in the gearbox involves disadvantages, such as heating of the discs of the clutch mechanism, which results in an increased fuel consumption and a wear of the clutch discs. This is particularly relevant upon connection of the shafts. Furthermore, a conventional clutch mechanism is relatively heavy and costly. It also occupies a relatively large space in the vehicle. Friction losses also occur upon use of a hydraulic converter/torque transformer commonly used in automatic gearboxes.

The conventional clutch mechanism as well as the hydraulic converter and said disadvantages associated therewith may be avoided by providing for that the vehicle has a propulsion system in which the output shaft of the combustion engine, the rotor of the electric machine and the input shaft of the gearbox are interconnected by a planetary gear. A vehicle having a propulsion system of this type is known through EP 1 319 546. There is of course an ongoing attempt to improve the way to drive a vehicle having such a propulsion system with respect to energy efficiency and the way that the electric machine and the combustion engine interact.

### SUMMARY OF THE INVENTION

The object of the present invention is to provide a method of the sort initially defined considering the attempt mentioned above. This object is according to the invention achieved by providing a method according to the appended claim 1.

In order to start the combustion engine according to the inventive method, a vehicle with a propulsion system of the abovementioned type is set in an initial position with a brake applied and a suitable gear engaged in the gearbox. The electric machine cranks the combustion engine via the planetary gear whereafter the vehicle, on a given signal, may take off directly without additional gear changing. The vehicle may therefore be brought to take-off quickly after starting the combustion engine by easing off the engaged brake and demand a propelling torque using the accelerator. This method is particularly advantageous for short breaks when the combustion engine keeps warm during the break, for example in urban transport or for a bus at a bus stop. The combustion engine is thereby started when the vehicle is still standing, whereafter take-off takes place. The method is also suitable for starting the combustion engine when the vehicle is moving and is propelled solely by the electric machine, for example at the end of a downhill slope before a climb.

According to an embodiment of the invention, the method is carried out for a propulsion system in which said first component is the sun gear, said second component is the planetary gear carrier and said third component is the ring gear. Such a propulsion system is described in the still unpublished SE 1051384-4. By connecting the electric machine to the ring gear and the output shaft of the combustion engine to the sun gear, a compact construction is achieved, which is easy to fit into already existing spaces for propulsion systems having clutch mechanisms instead of planetary gears. Thereby, a hybridized gearbox may be made size and weight compatible with a standard gear box and standardized interfaces may be maintained. This means that the weight increase normally associated with hybridization may be reduced considerably. Another advantage is that a connection of the electric machine to the ring gear gives a higher possible brake torque associated with the electric machine than had it instead been connected to the sun gear.

According to an embodiment of the invention, the electric machine is in step b) controlled so that the combustion engine reaches its idle rotation speed. This results in lower noise level and the combustion engine reaches its idle rotation speed faster than by producing torque by itself for accelerating up to the idle rotation speed.

According to an embodiment of the invention, a brake is in step (a) applied to the input shaft of the gear box by means of the service brake of the vehicle. According to another embodiment of the invention, a brake is in step (a) applied to the input shaft of the gearbox by means of the parking brake of the vehicle. Also some other braking mechanism such as a mechanic lock or a countershaft brake may be used.

According to an embodiment of the invention, the method is carried out for a propulsion system wherein the output shaft of the combustion engine is connected to said first component of the planetary gear at a fixed transmission ratio, and/or wherein the input shaft of the gearbox is connected to said second component of the planetary gear at a fixed transmission ratio.

According to an embodiment of the invention, the method is carried out for a propulsion system wherein the output shaft of the combustion engine is connected to said first component of the planetary gear so that these rotate as a unit with the same rotation speed and/or wherein the input shaft of the gearbox is connected to said second component of the planetary gear so that these rotate as a unit with the same rotation speed.

The invention also relates to a computer program having the features listed in claim 10, a computer program product having the features listed in claim 11, an electronic control unit having the features listed in claim 12 and a vehicle having the features listed in claim 13.

Other advantageous features and advantages of the invention will appear from the description following below.

### BRIEF DESCRIPTION OF THE DRAWINGS

The invention will in the following be further described by means of example with reference to the appended drawings, wherein

FIG. 1 is a schematic drawing of a propulsion system of a vehicle for which a method according to the invention may be carried out,

FIG. 2 is a simplified view of a part of a propulsion system,

FIG. 3 shows how the torque of the different components in the propulsion system can vary over time when carrying out the method,

FIG. 4 shows how the rotation speed of the components in FIG. 3 may vary over time when carrying out the method,

FIG. 5 is a schematic drawing of a control unit for implementing a method according to the invention, and

FIG. 6 is a flow chart illustrating a method according to the invention.

### DETAILED DESCRIPTION OF EMBODIMENTS OF THE INVENTION

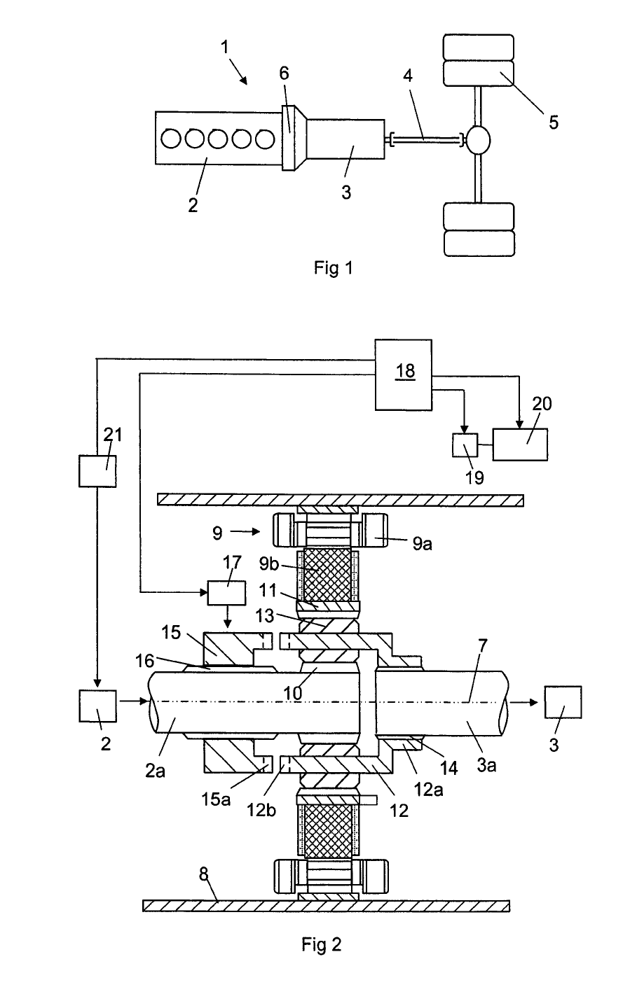

FIG. 1 shows a propulsion system 1 for a heavy vehicle. The propulsion system comprises a combustion engine 2, a gearbox 3, a number of drive shafts 4 and drive wheels 5. Between the combustion engine 2 and the gearbox 3 the propulsion system 1 comprises an intermediate portion 6.

FIG. 2 shows a more detailed view of the components in the intermediate portion 6. The combustion engine 2 is provided with an output shaft 2a and the gear box 3 with an input shaft 3a in the intermediate portion 6. The output shaft 2a of the combustion engine is coaxially arranged with respect to the input shaft 3a of the gear box. The output shaft 2a of the combustion engine and the input shaft 3a of the gear box are arranged to rotate around a common rotation axis 7. The intermediate portion 6 comprises a housing 8 enclosing an electric machine 9 and a planetary gear. The electric machine 9 comprises as usual a stator 9a and a rotor 9b. The stator 9a comprises a stator core secured in a suitable way on the inside of the housing 8. The stator core comprises the windings of the stator. The electric machine 9 is adapted to, in certain operation situations, utilize stored electric energy for supplying propelling force to the input shaft 3a of the gearbox and, in other operation situations, utilize kinetic energy of the input shaft 3a of the gear box to extract and store electric energy.

The planetary gear is arranged essentially radially internally of the stator 9a and rotor 9b of the electric machine. The planetary gear comprises as usual a sun gear 10, a ring gear 11 and a planet wheel carrier 12. The planet wheel carrier 12 carries a number of gear wheels 13 being rotatably arranged in a radial space between the teeth of the sun gear 10 and the ring gear 11. The sun gear 10 is secured to a circumferential surface of the output shaft 2a of the combustion engine. The sun gear 10 and the output shaft 2a of the combustion engine are here arranged to rotate as a unit with a first rotation speed n₁. The planet wheel carrier 12 comprises a fastening portion 12a being fastened to a circumferential surface of the input shaft 3a of the gearbox by means of a splined connection 14. By means of this connection, the planet wheel carrier and the input shaft 3a of the gearbox may rotate as a unit with a second rotation speed n₂. The ring gear 11 comprises an external circumferential surface onto which the rotor 9b is secured. The rotor 9b and the ring gear 11 form a rotatable unit arranged to rotate with a third rotation speed n₃.

The propulsion system 1 comprises in this embodiment also locking means for interlocking two of the components of the planetary gear. The locking means are here arranged on the output shaft 2a of the combustion engine and on the planet wheel carrier 12 by means of a displaceable coupling member 15 provided on the output shaft 2a of the combustion engine, which coupling member 15 via a coupling portion 15a is connectable to a coupling portion 12b of the planet wheel carrier 12. The coupling member 15 is fastened to the output shaft 2a of the combustion engine by means of a splined connection 16. The coupling member 15 is in this case fixed against rotation to the output shaft 2a of the combustion engine and displaceable in an axial direction on the output shaft 2a of the combustion engine. A schematically illustrated displacing member 17 is adapted to displace the coupling member 15 between a first position in which the coupling portions 15a, 12b are not mutually engaged, corresponding to a releasing position of the locking means, and a second position in which the coupling portions 15a, 12b are mutually engaged, corresponding to a locking position of the locking means. When the coupling portions 15a, 12b are mutually engaged, the output shaft 2a of the combustion engine and the input shaft 3a of the gearbox will be interlocked. These two axes 2a, 3a and the rotor 9b of the electric machine will thereby rotate with the same rotation speed.

In the illustrated embodiment, an electric control unit 18 is adapted to control the displacing member 17. The control unit 18 is also adapted to determine the occasions on which the electric machine 9 shall operate as a motor and on which occasions it shall operate as a generator. In order to make this decision, the control unit 18 may receive current information about suitable operating parameters. The control unit 18 may be a computer with suitable software for this task. The control unit 18 also controls a schematically shown regulating equipment 19 regulating the flow of electric energy between an energy storing means 20, such as a hybrid battery, and the stator 9a of the electric machine. On occasions upon which the electric machine operates as a motor, stored electric energy is supplied from the energy storing means 20 to the stator 9a and/or to other consumers. On occasions upon which the electric machine operates as a generator, electric energy is supplied from the stator 9a to the energy storing means 20. The energy storing means 20 delivers and stores electric energy with a voltage in order of 200-800 Volt. Since the intermediate portion 6 between the combustion engine 2 and the gearbox 3 in a vehicle is restricted, it is required that the electric machine 9 and the planetary gear constitute a compact unit. The components 10-12 of the planetary gear are here arranged substantially radially internally of the stator 9a of the electric machine. The rotor 9b of the electric machine, the ring gear 11 of the planetary gear, the output shaft 2a of the combustion engine and the input shaft 3a of the gearbox are here arranged to rotate around a common axes of rotation 5. Through such a design, the electric machine 9 and the planetary gear occupies a comparatively small space. The vehicle is provided with a motor control function 21 through which the rotation speed n₁ of the combustion engine may be regulated. The control unit 18 thereby has a possibility to activate the motor control function 21 upon engagement and disengagement of gears in the gearbox 3 in order to create a state of zero torque in the gearbox 3. The propulsion system may of course, instead of being controlled by one single control unit 18, be controlled by several different control units.

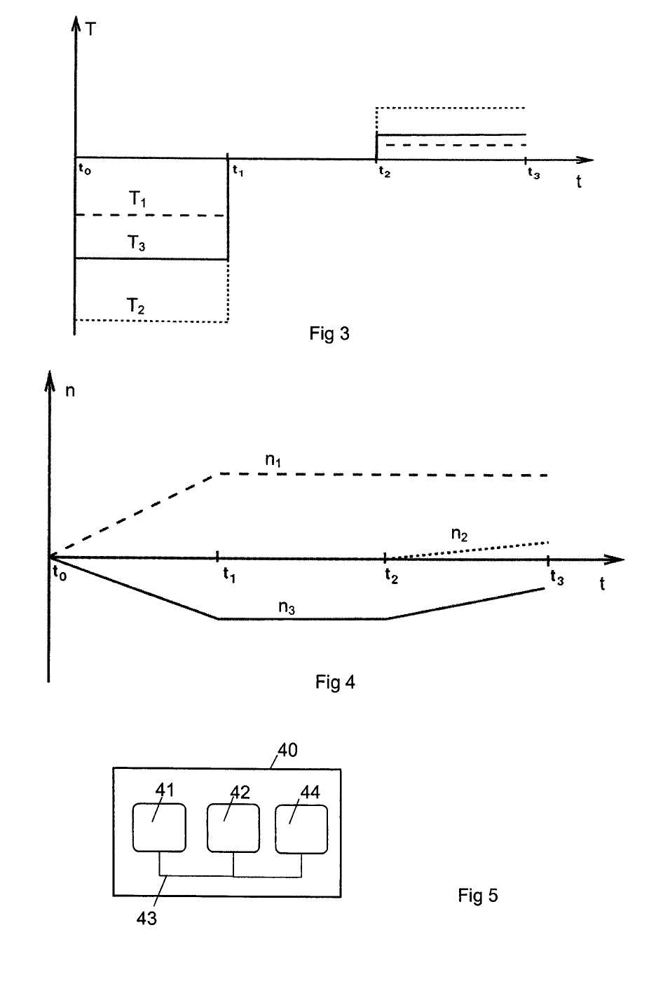

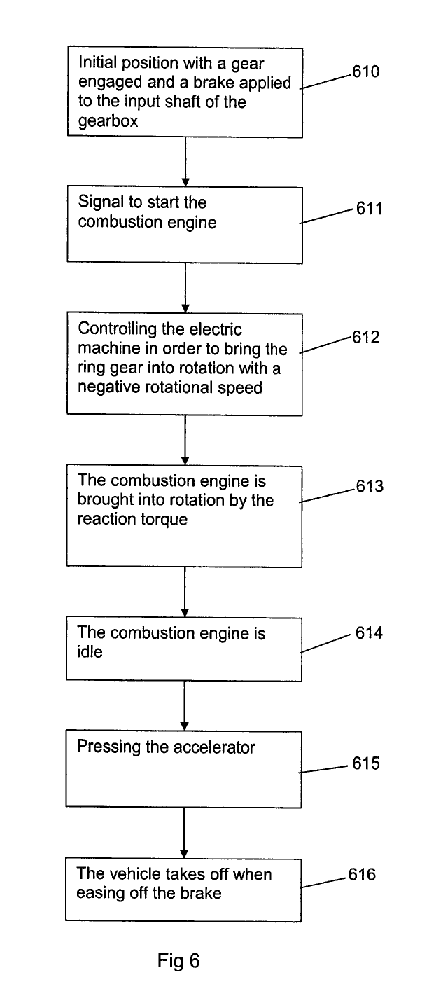

FIGS. 3 and 4 show how the torques T₁, T₂ and T₃ and the rotation speeds n₁, n₂ and n₃ for the output shaft 2a of the combustion engine (dashed line), the input shaft 3a of the gearbox (dotted line) and the rotor 9b of the electric machine (solid line), respectively, may vary over time t while carrying out an embodiment of the method according to the invention. By definition, the combustion engine 2, which only rotates one way, rotates with a positive rotation speed. Components rotating in the same direction as the combustion engine thereby by definition rotate with a positive rotation speed and components rotating in an opposite direction by definition rotate with a negative rotation speed. In this embodiment of the inventive method, a propulsion system 1 in which the rotor 9b of the electric machine is arranged to rotate as a unit with the ring gear 11, the output shaft 2a of the combustion engine is arranged to rotate as a unit with the sun gear 10 and the input shaft 3a of the gearbox is arranged to rotate as a unit with the planet wheel carrier 12 is used. FIG. 6 shows a flow chart illustrating the method.

Upon starting the combustion engine 2 according to the present invention, the vehicle is first put in a suitable initial position 610, which may be either a standing position, which is the case in the course shown in FIGS. 3 and 4, or a position in which a brake is applied to the vehicle. In the initial position, a brake is applied to the input shaft 3a of the gearbox and slows down the rotation thereof, while simultaneously a suitable gear is engaged in the gearbox 3. The locking means are in the releasing position. Which gear is appropriate to engage depends on many factors, such as the weight of the vehicle, the slope of the ground, the velocity of the vehicle, the type of gearbox, the driving direction, etc. In a standing initial position a gear suitable for take-off should be engaged. If the combustion engine is to be started while driving forward, a suitable initial position is obtained by braking through a brake mechanism (not shown) acting on the input shaft 3a of the gearbox. In this embodiment, applying a brake to the input shaft 3a of the gearbox directly results in a braking of the planet wheel carrier 12 connected to the shaft 3a.

When the combustion engine 2 in step 611 is to be started at the time t=t₀, the electric machine 9 receives a signal from the control unit 18. The electric machine 9 in a step 612 applies a negative torque T₃ acting on the ring gear 11, so that the ring gear via the rotor 9b is brought into rotation with a negative rotation speed n₃. The electric machine 9 now functions as a motor which can crank the combustion engine 2, since the rotation of the ring gear 11 in combination with the braking of the planet wheel carrier 12 via the input shaft 3a of the gear box gives a reaction torque T₁ acting on the sun gear 10. This reaction torque is in a step 613 transmitted via the sun gear 10 to the combustion engine 2. The output shaft 2a of the combustion engine thereby starts to rotate with an accelerating positive rotation speed n₁. The electric machine 9 suitably accelerates the combustion engine 2 until the latter at the time t=t₁ in a step 614 has reached its idle rotation speed. The ring gear 11 continues to rotate with a rotation speed n₃, but the torque T₃ is now zero. The combustion engine 2 is kept going by the idle speed control system until the driver at the time t=t₂ in a step 615 presses the accelerator. The brake acting on the input shaft 3a of the gearbox is then eased off in a step 616.

The electric machine 9 is now controlled towards a positive torque T₃, which is determined by the position of the accelerator. At the same time, the rotation speed of the combustion engine 2 is controlled such that the rotation speed is kept essentially constant. The electric machine 9 now functions as a generator and electric energy from the stator 9a is transferred to the energy storing means 20. Since the positive torque T₃ of the electric machine 9 acts to reduce the rotation speed n₁ of the combustion engine 2, the result thereof is that the motor control function 21, in order to keep the rotation speed of the combustion engine, controls the combustion engine so that it applies a positive torque T₁ acting on the sun gear 10. The result is that a resulting positive torque T₂ acts on the input shaft 3a of the gearbox. Since the brake is no longer acting on the planet wheel carrier 12, the input shaft 3a of the gearbox is accelerated and the vehicle takes off, simultaneously as the rotation speed n₃ of the electric machine is reduced towards zero. The inventive method has thereby come to an end and the combustion engine and the electric machine are hereafter controlled depending on the desired driving mode.

The torque of the electric machine is preferably controlled so that the electric machine cranks the combustion engine to its idle rotation speed during the starting procedure, but it is also possible to interrupt the control somewhat earlier and let the combustion engine accelerate by itself up to the idle rotation speed.

The brake which is applied to the input shaft of the gearbox during the starting procedure is preferably the service brake of the vehicle, but it may also be the parking brake or another braking mechanism which acts directly or indirectly on the input shaft of the gearbox or on the planet wheel carrier connected to this shaft. In this context, the braking mechanism acting indirectly on the input shaft of the gearbox means that the braking mechanism acts directly on a component connected to the input shaft of the gearbox, for example on the drive wheels of the vehicle. The parking brake and the service brake both act indirectly on the input shaft of the gearbox.

Computer program code for implementing a method according to the invention is suitably included in a computer program which is readable into an internal memory of a computer, such as the internal memory of an electronic control unit of a motor vehicle. Such a computer program is suitably provided through a computer program product comprising a data storing medium readable by an electronic control unit, which data storing medium has the computer program stored thereon. Said data storing medium is for example an optical data storing medium in the form of a CD-ROM-disc, a DVD-disc, etc., a magnetic data storing medium in the form of a hard disc, a diskette, a tape etc., or a Flash memory or a memory of the type ROM, PROM, EPROM or EEPROM.

FIG. 5 illustrates very schematically an electronic control unit 40 comprising an execution means 41, such as a central processor unit (CPU), for executing a computer program. The execution means 41 communicates with a memory 42, for example of the type RAM, through a data bus 43. The control unit 40 comprises also a data storing medium 44, for example in the form of a Flash memory or a memory of the type ROM, PROM, EPROM or EEPROM. The execution means 41 communicates with the data storing medium 44 through the data bus 43. A computer program comprising computer program code for implementing a method according to the invention is stored on the data storing medium 44.

The invention is of course not in any way restricted to the embodiments described above, but many possibilities to modifications thereof would be apparent to a person with skill in the art without departing from the scope of the invention as defined in the appended claims.

1. A method for starting a combustion engine in a propulsion system of a vehicle wherein, the propulsion system comprises a combustion engine with an output shaft, an electric machine comprising a stator and a rotor, a brake, a gearbox with an input shaft, and a planetary gear comprising three components in the form of a sun gear, a ring gear and a planet wheel carrier, the output shaft of the combustion engine being connected to a first of the components of the planetary gear so that rotation of the output shaft of the combustion engine causes rotation of the first component, the input shaft of the gearbox being connected to a second of the components of the planetary gear so that rotation of the input shaft of the gearbox causes rotation of the second component and the rotor of the electric machine being connected to a third of the components of the planetary gear, so that rotation of the rotor causes rotation of the third component; and
the method comprises the steps:
a) setting the vehicle in an initial position with a selected gear engaged in the gearbox and with the brake acting indirectly on the input shaft of the gearbox,
b) controlling the electric machine so that the third component is brought into rotation with negative rotation speed (n3) and the output shaft of the combustion engine is thereby, brought into rotation with a positive rotation speed (n1), via the first component of the planetary gear setting the combustion engine to be started.

2. The method according to claim 1, performed for a propulsion system wherein the output shaft of the combustion engine is connected to the sun gear, the input shaft of the gearbox is connected to the planet wheel carrier and the rotor of the electric machine is connected to the ring gear.

3. The method according to claim 1, further comprising controlling the electric machine in step b) so that the combustion engine reaches its idle rotation speed.

4. The method according to claim 1, further comprising indirectly applying the brake to the input shaft of the gearbox by means of a service brake of the vehicle.

5. The method according to claim 1, further comprising indirectly applying the brake to the input shaft of the gearbox by means of a parking brake of the vehicle.

6. The method according to claim 1, performed for a propulsion system wherein the output shaft of the combustion engine is connected to the first component of the planetary gear at a fixed transmission ratio.

7. The method according to claim 1, performed for a propulsion system wherein the output shaft of the combustion engine is connected to the first component of the planetary gear such that the output shaft and the first component rotate as a unit with the same rotation speed.

8. The method according to claim 1, performed, for a propulsion system wherein the input shaft of the gearbox is connected to the second component of the planetary gear at a fixed transmission ratio.

9. The method according to claim 1, performed for a propulsion system wherein the input shaft of the gearbox is connected to the second component of the planetary gear such that the input shaft and the second component rotate as a unit with the same rotation speed.

10. (canceled)

11. A computer program product comprising a data storing medium with a non-volatile memory, computer code of a computer program stored in the memory and executable by a computer, in which the computer program code of the computer program implements a method according to claim 1 when the computer program code is executed in the computer.

12. An electronic control unit comprising an execution means, a non-volatile memory connected to the execution means and a data storing medium connected to the execution means, and computer program code of a computer program being stored on the data storing medium, wherein the program code implements a method according to claim 1 when the computer program code is executed in the computer.

13. A vehicle comprising an electronic control unit according to claim 12.
